(19) United States
(12) Patent Application Publication
(10) Pub. No.: US 2026/0042547 A1
(43) Pub. Date: Feb. 12, 2026

(54) REFUELING SYSTEM AND METHOD OF A TANKER AIRCRAFT COMPRISING A BOOM HOSE ADAPTOR

(71) Applicant: AIRBUS DEFENCE AND SPACE S.A.U., Madrid (ES)

(72) Inventor: Bruno MARTÍNEZ VÁZQUEZ, Madrid (ES)

(21) Appl. No.: 19/360,760

(22) Filed: Oct. 16, 2025

Related U.S. Application Data
(63) Continuation of application No. PCT/ES2024/070084, filed on Feb. 15, 2024.

(30) Foreign Application Priority Data
Apr. 19, 2023 (EP) 23382362.4

(51) Int. Cl. B64D 39/06; B64D 39/04; B64D 39/02

(52) U.S. Cl. CPC B64D 39/06; B64D 39/04; B64D 39/02

(57) ABSTRACT

A refueling system and method of a tanker aircraft (1) includes: a rigid boom (5); a boom hose adaptor (9) having a hose portion (8), and a coupling end (4); a sensor in the tanker aircraft (1) and collecting data of the situation of the receiver aircraft (3) with respect to the tanker aircraft (1), and a controller in the tanker aircraft (1) and in communication with the sensor to receive the data from the sensor, and the tanker aircraft (1) to control the a position of the rigid boom (5) to place the boom hose adaptor (9) within a range of positions according to the data obtained from the sensor.

### RELATED APPLICATIONS

This application is a continuation application of International Patent Application PCT/ES2024/070084, filed February 15, 2024, which claims priority to European Patent application 23382362.4, filed April 19, 2023, both of which applications are incorporated by reference.

### TECHNICAL FIELD

The invention relates to the field of aerial refueling. More specifically, the invention relates to a system and a method to improve a refueling operation involving a boom hose adaptor.

### BACKGROUND

In air-to-air refueling, a tanker aircraft deploys a refueling hose or boom to refuel a receiver aircraft during flight. There are two main technologies in air-to-air refueling, which are the hose and drogue system and the rigid boom system.

FIG. 1 illustrates the hose and drogue system. A receiver aircraft 3 includes an aerial refueling probe 7. The pilot of the receiver aircraft maneuvers the aircraft to couple the refueling problem 7 with a drogue 4 at an end of a hose 2 extended from behind a wing of a tanker aircraft 1. The refueling probe 7 is typically a rigid, protruding or pivoted retractable arm on the receiver aircraft, at its nose or fuselage. At the end of the probe there is a valve that is closed until it mates with the drogue's forward internal receptacle, after which the valve opens and allows fuel to pass from the tanker aircraft to the receiver aircraft.

The hose 2 is trailed from a drum located at the tanker aircraft. The hose and drum may extend from the tail section of the tanker aircraft or from a wing of the tanker aircraft. The drum comprises a drum actuator that assures the correct tension of the hose while the coupling end is in contact with the probe of the receiver aircraft. The drum actuator is configured to absorb the relative movements between the tanker aircraft and the receiver aircraft while connected. Therefore, the hose and drogue system does not require the action of any operator on-board to keep a relative distance between both aircraft.

FIG. 2 illustrates a rigid boom 5 extending from the tanker aircraft 1. The receiver aircraft positions itself behind the tanker aircraft and within reach of the boom. The rigid boom is typically a non-flexible tube 5.1 from which extends a telescoping telescopic beam 5.2. A boom operator in the tanker aircraft extends the beam 5.2 and operates flight control surfaces, e.g., vanes, on the boom, to move the end of the beam into engagement with a refueling port on the receiver aircraft 3. Once engaged, fuel is pumped from the receiver aircraft into the receiver aircraft.

Compared to the hose and drogue method, the rigid boom method has two main advantages. The first advantage is that the rigid boom has the capacity to transfer fuel at a greater flow rate, and the second advantage is that the amount of fuel per minute, and secondly, the receiver position behind the tail cone of the tanker aircraft is normally more stable than the receiver position behind the wing.

A boom hose adaptor has been developed to allow a probe-equipped receiver aircraft to refuel from a boom-equipped tanker aircraft. An embodiment is disclosed in FIG. 3 of the description. The boom attached to the tanker aircraft is equipped with a hose portion and a coupling end.

However, a boom-equipped tanker aircraft with a boom hose adaptor does not have automatic tension control as the known hose system previously explained. It forces the receiver aircraft to generate an S-shape deformation in the hose portion. An embodiment is disclosed in FIG. 4 of the description. This S-shaped hose portion allows relative movements between the tanker aircraft and the receiver aircraft, but these movements are limited to small amplitudes, only compatible with small receiver aircraft. Larger receiver aircraft have larger relative movements that would require a larger S-shape. This is not possible as the length of the hose portion trailing over the rigid boom in a boom hose adaptor configuration is limited by the dimensions of the tanker aircraft. As a consequence, the use of the boom hose adaptor in large receiver aircraft is not allowed.

Some tankers equipped with a rigid boom are also equipped with sensors or cameras that identify the position of the receiver aircraft and drive the rigid boom until the contact with the receiver aircraft is made without the action of the boom operator. However, those systems are not configured to operate when the rigid boom is equipped with a boom hose adaptor, as they are not designed in order to predict nor control the behavior of the attached drogue.

### SUMMARY

The invention may be embodied as is a system or a method that allow the use of a boom hose adaptor in large receiver aircraft.

The refueling system comprises: a rigid boom configured to be extended from the tanker aircraft and comprising a distal end with respect to the tanker aircraft, i.e., an end away from the tanker aircraft; the boom hose adaptor comprising: a hose portion in contact with the distal end of the rigid boom, for instance, attached to the distal end, and a coupling end located at a free end of the hose portion, i.e., at the end of the hose portion furthest from the rigid boom. The coupling end is configured for making contact with a probe of a receiver aircraft; at least a sensor configured to be located into the tanker aircraft and to obtain data of the situation of the receiver aircraft with respect to the tanker aircraft, i.e., the way in which the receiver aircraft is placed in relation to its surroundings and specifically to the tanker aircraft’ a controller configured to be located into the tanker aircraft and connectable to: the sensor to receive data from the sensor, and the tanker aircraft to control the position of the rigid boom to place the boom hose adaptor within a suitable range of positions determined from the data of the parameter obtained from the sensor.

The above system automatically controls the position of the rigid boom equipped with a boom hose adaptor to allow and simplify the refueling process, in particular for large receiver aircraft. The range of positions allow to absorb the relative movements between the receiver aircraft and the tanker aircraft.

The rigid boom is extendable, and its distal end is also vertically and laterally movable and within a cone of positions.

Particularly, the system comprises a sensor located in the tanker aircraft that obtains data of at least a parameter of the behavior of the receiver aircraft with respect to the tanker aircraft. In an embodiment it is the position and/or attitude of the receiver aircraft with respect to the tanker aircraft.

Position is understood as latitude, longitude, altitude, and time data, while attitude is understood as angular difference measured between an airplane's axis and the line of the Earth's horizon.

The sensor may be, for instance, a vision system that determines the relative position between the tanker aircraft and the receiver aircraft. The refueling system may in addition comprise a load sensor that measures the hose forces between the tanker aircraft and the receiver aircraft when coupled.

According to the above obtained data, the controller controls the position of the rigid boom.

The receiver aircraft is no longer forced to maintain a relatively stable position, and can therefore move within a greater operational envelope, that can correspond to the maximum available envelope of the tanker boom system. The control of the position of the rigid boom will avoids the constraints of the state of the art related to the limitations of the S-shape hose portion.

It is also an object of the invention a tanker aircraft comprising a boom hose adaptor and a refueling system according to the above.

It is also an object of the present invention a refueling method of a tanker aircraft comprising a boom hose adaptor comprising the following steps: approaching between the receiver aircraft and the tanker aircraft, in an embodiment, the receiver aircraft approaches the tanker aircraft, extending the rigid boom from the tanker aircraft, contacting the coupling end of the tanker aircraft with the probe of the receiver aircraft, obtaining data of the situation of the receiver aircraft with respect to the tanker aircraft by a sensor located into the tanker aircraft, receiving data from the sensor by a controller located into the tanker aircraft, controlling by the controller the position of the rigid boom to place the boom hose adaptor within a range of positions according to the data received from the sensor.

### SUMMARY OF FIGURES

To complete the description and to provide for a better understanding of the invention, a set of drawings is provided. Said drawings form an integral part of the description and illustrate preferred embodiments of the invention. The drawings comprise the following figures.

FIG. 1 shows a schematic representation of a tanker aircraft and a receiver aircraft being refueled by a hose and drogue system according to the state of the art.

FIG. 2 shows a schematic representation of a tanker aircraft and a receiver aircraft being refueled by a rigid boom system according to the state of the art.

FIG. 3 shows a schematic representation of a tanker aircraft and a probe-equipped receiver aircraft being refueled by a rigid boom system and a boom hose adaptor according to the state of the art.

FIG. 4 shows a schematic representation of the tanker aircraft and the probe-equipped receiver aircraft of FIG. 3 with the hose portion describing an S-shape to adapt the refueling system to the relative movements between the tanker aircraft and the receiver aircraft.

FIG. 5 shows a schematic representation of a tanker aircraft and a receiver aircraft being refueled by a rigid boom system and a boom hose adaptor according to an embodiment of the invention.

FIG. 6 shows a schematic representation of an embodiment of a load sensor based on the use of strain gauges.

### DETAILED DESCRIPTION OF THE INVENTION

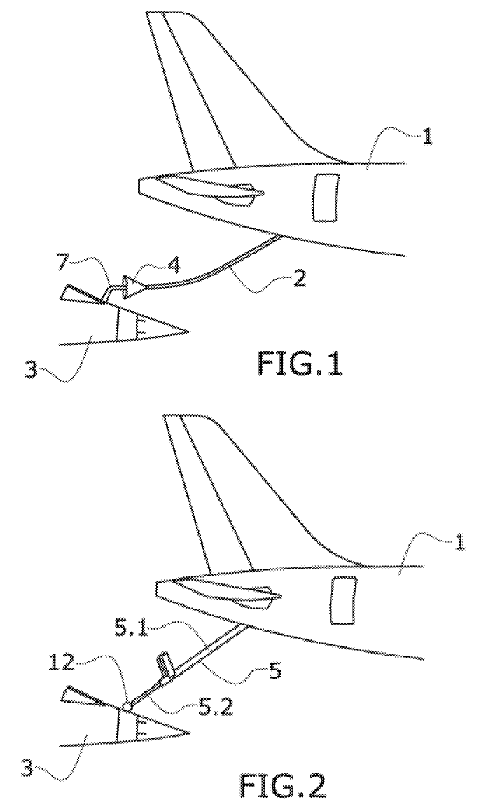

FIG. 1 discloses a schematic representation of a tanker aircraft (1) and a receiver aircraft (3) being refueled by a hose and drogue system according to the state of the art. The receiver aircraft (3) moves towards the tanker aircraft (1) and tries to connect to a coupling end (4) or drogue located at the end of the trailed hose (2). The receiver aircraft (3) comprises a probe (7) to make contact with the coupling end (4) of the deployed hose (2).

As previously explained, the above system does not require the action of any operator on-board as a drum actuator located at the tanker aircraft (1) assures the correct tension of the hose (2) while the tanker aircraft (1) and the receiver aircraft (3) are in contact. The drum actuator, therefore, help to absorb the relative movements between the tanker aircraft (1) and the receiver aircraft (3).

In a boom system, the receiver aircraft (3) moves to a fixed position and a rigid boom (5) attached to the tail of the tanker aircraft (1) is piloted by a boom operator inside the tanker aircraft (4) until the contact. The rigid boom (5) comprises a rigid fixed section (5.1) and a telescopic section (5.2).

Several tanker aircraft (1) are equipped with a load sensor (12) located at the end of the rigid boom (5) to measure the loads induced on the system due to the relative movements of the receiver aircraft (3) with respect to the tanker aircraft (1) and, by automatically controlling the position of the rigid boom (5) to minimize such loads. Those load sensors (12) are only designed to achieve a rigid union between the rigid boom (5) and the receiver aircraft (3).

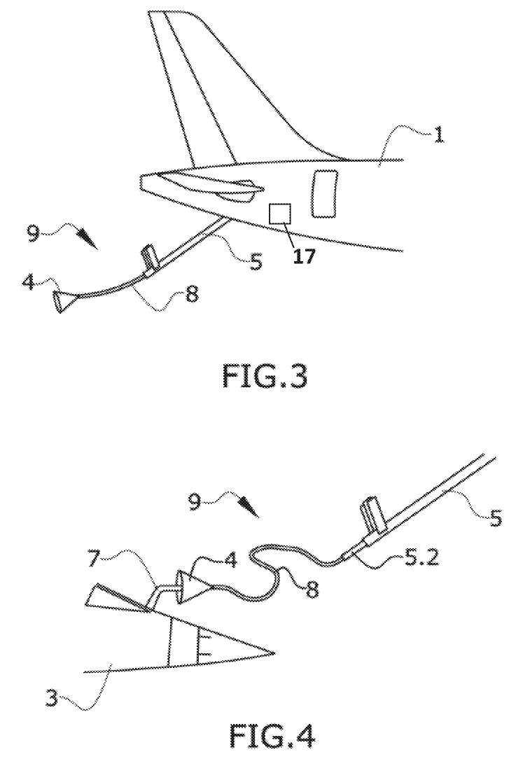

FIG. 3 discloses a schematic representation of a tanker aircraft (1) and a receiver aircraft (3) being refueled by a rigid boom (5) and a boom hose adaptor (9) according to the state of the art. The boom hose adaptor (9) has been developed to allow a probe (7) equipped receiver aircraft (3) to be refueled from a rigid boom (5). More specifically, the rigid boom (5) attached to the tanker aircraft (1) is equipped with a boom hose adaptor (9) comprising a portion of a hose (8) and a coupling end (4) or drogue at its end. The hose portion (8) is attached to the distal end of the rigid boom (5).

As there is no drum to deploy the hose portion (8), there is no possibility to absorb the relative movements between the receiver aircraft (3) and the tanker aircraft (1). Thus, the receiver aircraft (3) is forced to generate an S- shape deformation in the hose portion (8) in order to absorb said relative movements. This situation is depicted in FIG. 4.

In an embodiment of the invention, the sensor is a vision system and the controller (17) is configured to determine the relative position between the tanker aircraft (1) and the receiver aircraft (3). The controller may be a computer including a processor receiving data from one or more sensors and commands from a boom operator in the aircraft. The controller may process the data and received commands to generate and output control commands to the rigid boom to maneuver the boom and extend or retract the telescopic section of the rigid boom.

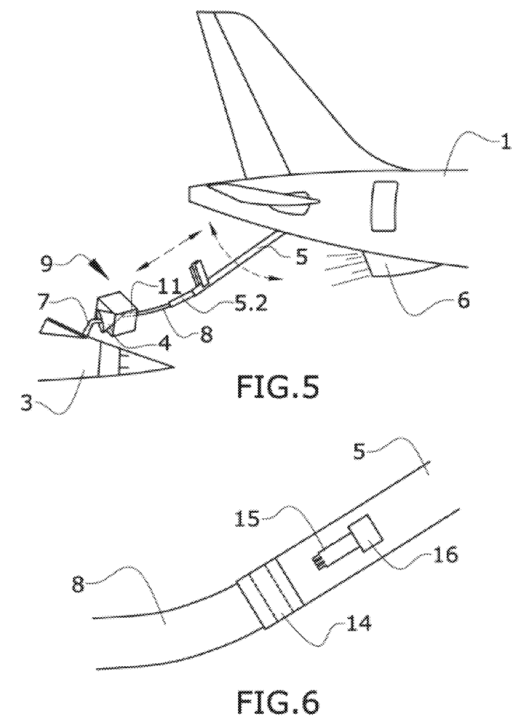

In the embodiment disclosed in FIG. 5 the vision system is a camera (6) located in the tanker aircraft (1) and pointing to the receiver aircraft (3). The camera (6) is configured to automatically identify the receiver aircraft (3) and to determine the relative position between the tanker aircraft (1) and the receiver aircraft (3).

According to this computed relative position, the refueling system automatically controls the rigid boom (9) in order to place the coupling end (4) of the boom hose adaptor (9) into, for instance, a specific position or in a virtual box (11) according to the position of the receiver aircraft (3).

The controller (17) is configured to move the rigid boom (5) in a lateral movement, vertical movement and/or elongation (10) to place the hose portion (8) in an optimum position.

More specifically, the controller (17) is configured to change the orientation of the rigid boom (5) in any angular direction with respect to the tanker aircraft (1) and/or generate an elongation of the telescopic section (5.2) of the rigid boom (5).

FIG. 5 discloses an embodiment of the refueling system comprising:

A rigid boom (5) attached to a tanker aircraft (1) comprising a rigid section (5.1) able to have vertical and lateral movement and a telescopic section (5.2) able to have longitudinal movements along its axis.

A boom hose adaptor (9) comprising a hose portion (8) and a coupling end (4) attached to the end of the telescopic section of the rigid boom (5).

A vision system comprising a set of cameras (6) and controller installed on the tanker aircraft (1). The control mean is able to identify the position of the receiver aircraft (3) on the acquired images and in consequence determine the distance and relative position with respect to the tanker aircraft (1).

The controller identifies through the cameras (6) the position of the receiver aircraft (3) and automatically controls the rigid boom (5) in at least one of its degree of freedom in order to place the coupling end (4) of the boom hose adaptor (9) into an adequate position for the refueling operation.

In an embodiment, the vision system is based on an infrared system.

In another embodiment, the vision system is based on a Light Detection and Ranging (LIDAR) system.

In another embodiment, the vision system is based on the thermal gradient of the receiver aircraft (3) and its surrounding environment.

In another embodiment, the sensor is a differential navigation system were the relative position between the tanker aircraft (1) and the receiver aircraft (3) is determined by the control system by analyzing the difference of geographical position determined by the navigation suites installed on the tanker aircraft and those installed on the receiver aircraft.

In another embodiment, the sensor is a differential global positioning system were the relative position between the tanker aircraft (1) and the receiver aircraft (3) is determined by the control system by analyzing the difference of geographical position determined by a global positioning system (GPS, ...) installed in the tanker aircraft and another installed on the receiver aircraft.

The refueling system further comprises a load sensor located (13) in the rigid boom (5) or in the boom hose adaptor (9). The load sensor (13) is configured such that measures the forces between the tanker aircraft (1) and the receiver aircraft (3) when in contact. Prior to the contact the load sensor (13) does not provide valuable information, the refueling system relies on, for instance, the vision system.

FIG. 6 depicts an embodiment of a load sensor (13). The rigid boom (5) is attached to the flexible hose (8) through a flexible mechanical link (14). At the end of the rigid boom (5) are located a set of strain gauges (15) that generates electrical signal according to the efforts applied. Those electrical signals are conditioned by an electronic circuit (16) and transmitted to a boom control system inside the tanker aircraft (1). The boom control system maybe the same control system connectable to the sensor or a different control system.

In addition, the rigid boom (5) or the boom hose adaptor (9) comprises a sensor configured to indicate if the receiver aircraft (3) is latched to the boom hose adaptor coupling end (4).

The rigid boom (5) is controlled in different ways if the receiver aircraft (3) is latched to the boom hose adaptor coupling end (4): If the receiver aircraft (3) is latched to the boom hose adaptor coupling end (4), the system moves the rigid boom (5) in such way to minimize the tension on the hose section (8) in an analogue way that a drum installed in a tanker aircraft (1) does in a hose and drogue system, or if the receiver aircraft (3) is not latched to the boom hose adaptor coupling end (4), the system moves the rigid boom (5) to the optimum position to perform the contact, or to a safe position if the contact has finished.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or "comprising" do not exclude other elements or steps, the terms "a" or "one" do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A refueling system of a tanker aircraft comprising:
a rigid boom configured to extend from the tanker aircraft and comprising a distal end which is distal to the tanker aircraft;
a boom hose adaptor comprising a hose portion in contact with the distal end of the rigid boom, and a coupling end located at a free end of the hose portion, wherein the coupling end is configured to contact with a probe of a receiver aircraft,
a sensor configured to be located in the tanker aircraft and obtain data of a situation of the receiver aircraft with respect to the tanker aircraft, and
a controller configured to be located into the tanker aircraft and configured to receive data from the sensor and cause the tanker aircraft to control a position of the rigid boom to place the boom hose adaptor within range of positions according to the data obtained from the sensor.

2. The refueling system, according to claim 1, wherein the sensor is configured to determine the relative position and/or attitude between the tanker aircraft and the receiver aircraft, and the data includes information representing the relative position and/or attitude.

3. The refueling system, according to claim 2, wherein the sensor is a vision system.

4. The refueling system, according to claim 3, wherein the vision system is based on infrared technology.

5. The refueling system, according to claim 3, wherein the vision system is based on a Light Detection and Ranging (LIDAR) technology.

6. The refueling system according to claim 3, wherein the vision system is based on a thermal gradient of the receiver aircraft and an environment surrounding the tanker or receiver aircraft.

7. The refueling system according to claim 2, wherein the sensor is a differential navigation system and the controller is further configured to determine the relative position between the tanker aircraft and the receiver aircraft.

8. The refueling system according to claim 2, wherein the sensor is a differential global positioning system, and the controller is configured to determine the relative position between the tanker aircraft and the receiver aircraft.

9. The refueling system according to claim 1, further comprising a load sensor located in the rigid boom or in the boom hose adaptor, wherein the load sensor is configured to measure forces between the tanker aircraft and the receiver aircraft when the receiver aircraft is in contact with the refueling system.

10. The refueling system according to claim 1, wherein the rigid boom comprises a rigid fixed section and a telescopic section.

11. The refueling system according to claim 10, wherein the controller is configured to control the position of the rigid boom by changing the orientation of the rigid boom in any angular direction with respect to the tanker aircraft and/or generate an elongation of the telescopic section of the rigid boom.

12. The refueling system according to claim 1, wherein the rigid boom or the boom hose adaptor comprise a sensor configured to indicate that the receiver aircraft is latched to the boom hose adaptor coupling end.

13. A tanker aircraft comprising the refueling system according to claim 1.

14. A refueling method of a tanker aircraft comprising a boom hose adaptor, the tanker aircraft comprising:
a rigid boom configured to be extended from the tanker aircraft and comprising a distal end with respect to the tanker aircraft, and
the boom hose adaptor comprising a hose portion in contact with the distal end of the rigid boom, and a coupling end located at a free end of the hose portion, the coupling end configured to contact with a probe of a receiver aircraft,
the method comprising:
extending the rigid boom from the tanker aircraft,
contacting the coupling end of the boom hose adapter with the probe of the receiver aircraft,
obtaining data of a position and/or orientation of the receiver aircraft relative to the tanker aircraft by a sensor on the tanker aircraft,
receiving data from the sensor by a controller on the tanker aircraft,
controlling by the controller the position of the rigid boom to maneuver the boom hose adaptor within a range of positions according to the data received from the sensor.

15. A refueling system of a tanker aircraft comprising:
a rigid boom configured to extend from the tanker aircraft, the rigid boom includes a proximal end section attached to the tanker aircraft and a distal end section opposite to the proximal end section along a length of the rigid boom, and the rigid boom is configured to deliver fuel stored in the tanker aircraft to the distal end section;
a boom hose adaptor connected to the distal end section of the rigid boom, the boom hose adaptor includes a flexible hose having a proximal hose end connected to the distal end section of the rigid boom and a coupling hose end section opposite to the proximal hose end, wherein the coupling hose end is configured to engage a probe of a receiver aircraft and the boom hose adaptor is configured to delivery fuel from the rigid boom through the flexible hose into the probe of the receiver aircraft;
a differential navigation system or a differential global positioning system connected to the tanker aircraft and configured to determine a position or orientation of the receiver aircraft relative to the tanker aircraft and generate data within information regarding the position or the orientation of the receiver aircraft, and
a controller connected to the tanker aircraft and configured to receive the data and generate commands, using the data, to maneuver the rigid boom to position the flexible hose of the boom hose adaptor within a range of the probe while the coupling end of the boom hose adaptor engages the probe of the receiver aircraft.

16. The refueling system of claim 15, wherein the controller is configured to determine a relative position and/or an attitude between the tanker aircraft and the receiver aircraft, and the data includes information representing the relative position and/or attitude.

17. The refueling system according to claim 15, further comprising a load sensor mounted to the rigid boom or the boom hose adaptor, wherein the load sensor is configured to measure forces applied to the boom hose adaptor due to the coupling of the receiver aircraft with the boom hose adaptor, and
therein load data including information regarding the forces is generated by the load sensor and received by the controller, and the load data is used by the controller to maneuver the rigid beam.

18. The refueling system according to claim 15, wherein the controller is further configured to maneuver the rigid boom by adjusting a flight control surface on the rigid boom and by telescoping a telescoping beam of the rigid boom in and out of a fixed length boom of the rigid boom.

19. The refueling system according to claim 15, wherein the rigid boom or the boom hose adaptor comprise a sensor configured to indicate that the receiver aircraft is latched to the coupling house end section.
